(19) United States
(12) Patent Application Publication
(10) Pub. No.: US 2024/0281301 A1
(43) Pub. Date: Aug. 22, 2024

(54) EXECUTION PLATFORM DETERMINATION SYSTEM AND EXECUTION PLATFORM DETERMINATION METHOD

(71) Applicant: RAKUTEN MOBILE, INC., Tokyo (JP)

(72) Inventor: Shinya KITA, Setagaya-ku, Tokyo (JP)

(21) Appl. No.: 18/568,846

(22) PCT Filed: May 13, 2022
(86) PCT No.: PCT/JP2022/020272

§ 371 Date: Dec. 11, 2023

(51) Int. Cl. G06F 9/50

(52) U.S. Cl. CPC G06F 9/5083; G06F 9/505; G06F 2209/5019

(57) ABSTRACT

An AI/big-data processing module identifies, for each of a plurality of candidate platforms, a leveling index value indicating, in a case in which a to-be-added application has been constructed on the candidate platform, at least one of a degree of leveling of a resource usage status on the candidate platform or a degree of leveling of resource usage statuses among a plurality of the candidate platforms. A policy manager module determines, based on the leveling index value, an execution platform on which the to-be-added application is to be constructed from among the plurality of candidate platforms.

### TECHNICAL FIELD

The present invention relates to an execution platform determination system and an execution platform determination method.

### BACKGROUND ART

As an example of a technology relating to construction of each application such as a network function on an execution platform, in Patent Literature 1, there is described a technology for deconstructing an order of a product purchased by a customer into virtualized network function (VNF) units and deploying the VNF units on a network functions virtualization infrastructure (NFVI).

### CITATION LIST

### Patent Literature

[Patent Literature 1] WO 2018/181826 A1

### SUMMARY OF INVENTION

### Technical Problem

In such construction of each application as described in Patent Literature 1, it is general that each application is constructed on an execution platform in a round robin.

However, with this configuration, when, for example, the population of an area covered by each application executed on an execution platform is diverse, a resource usage status varies depending on the execution platform, and there have been some cases in which resources of execution platforms cannot be utilized effectively.

The present invention has been made in view of the above-mentioned circumstances, and has an object to provide an execution platform determination system and an execution platform determination method which are capable of effectively utilizing resources of an execution platform on which an application is constructed.

### Solution to Problem

In order to solve the above mentioned problem, according to one embodiment of the present invention, there is provided an execution platform determination system including: actual result value identification means for identifying, for each of a plurality of execution platforms on which an application to be added is executable, an actual result value of a resource usage status on the each of the plurality of execution platforms; predicted value identification means for identifying, for each of the plurality of execution platforms, a predicted value of the resource usage status on the each of the plurality of execution platforms obtained in a case in which the application has been constructed on the each of the plurality of execution platforms based on the actual result value relating to the each of the plurality of execution platforms; leveling index value identification means for identifying, for each of the plurality of execution platforms, based on the predicted value, a leveling index value indicating, in a case in which the application has been constructed on the each of the plurality of execution platforms, at least one of a degree of leveling of a resource usage status on the each of the plurality of execution platforms or a degree of leveling of resource usage statuses among the plurality of the execution platforms; and execution platform determination means for determining, based on the leveling index value, one of the plurality of execution platforms on which the application is to be constructed from among the plurality of the execution platforms.

In one aspect of the present invention, the actual result value identification means is configured to identify a total sum of actual result values of resource usage statuses in respective applications executed on the each of the plurality of execution platforms as the actual result value of the resource usage status on the each of the plurality of execution platforms.

Further, in one aspect of the present invention, the predicted value identification means is configured to identify the predicted value based on the actual result value of the resource usage status in a running application of the same type as the type of the application to be added.

Further, in one aspect of the present invention, the predicted value identification means is configured to identify predicted values for respective period types, and the leveling index value identification means is configured to identify the leveling index value based on the predicted values for the respective period types.

In this aspect, the leveling index value identification means may be configured to identify the leveling index value indicating, in the case in which the application has been constructed on the each of the plurality of execution platforms, a variation in the predicted values for the respective period types on the each of the plurality of execution platforms, and the execution platform determination means may be configured to determine, based on smallness of the variation indicated by the leveling index value, the one of the plurality of execution platforms on which the application is to be constructed.

As another example, the leveling index value identification means may be configured to identify the leveling index value indicating, in the case in which the application has been constructed on the each of the plurality of execution platforms, a difference between a maximum value and a minimum value of the predicted values for the respective period types on the each of the plurality of execution platforms, and the execution platform determination means may be configured to determine, based on smallness of the difference indicated by the leveling index value, the one of the plurality of execution platforms on which the application is to be constructed.

Further, in one aspect of the present invention, the leveling index value identification means is configured to identify, for each of the plurality of the execution platforms, the leveling index value indicating, in a case in which the application has been arranged on the each of the plurality of the execution platforms, a variation in the predicted values of the resource usage statuses among the plurality of the execution platforms, and the execution platform determination means is configured to determine, based on smallness of the variation indicated by the leveling index value, the one of the plurality of execution platforms on which the application is to be constructed.

Further, in one aspect of the present invention, the leveling index value identification means is configured to identify, for each of the plurality of execution platforms, the leveling index value indicating, in a case in which the application has been arranged on the each of the plurality of the execution platforms, a total sum of absolute values of differences between the predicted values of the resource usage statuses on the respective plurality of execution platforms and a predetermined value, and the execution platform determination means is configured to determine, based on smallness of the total sum of the absolute values of the differences indicated by the leveling index value, the one of the plurality of execution platforms on which the application is to be constructed.

Further, in one aspect of the present invention, the execution platform determination system further includes construction means for constructing the application on the determined one of the plurality of execution platforms.

Further, in one aspect of the present invention, the execution platform is a Kubernetes cluster.

Further, in one aspect of the present invention, the application is an application included in a communication system.

In this aspect, the application may be a network function.

Further, in one aspect of the present invention, the resource usage status is at least one of a usage status of a CPU, a usage status of a memory, a usage status of a storage, a usage status of a network, or a usage status of electric power.

Further, according to one embodiment of the present invention, there is provided an execution platform determination method including the steps of: identifying, for each of a plurality of execution platforms on which an application to be added is executable, an actual result value of a resource usage status on the each of the plurality of execution platforms; identifying, for each of the plurality of execution platforms, a predicted value of the resource usage status on the each of the plurality of execution platforms obtained in a case in which the application has been constructed on the each of the plurality of execution platforms based on the actual result value relating to the each of the plurality of execution platforms; identifying, for each of the plurality of execution platforms, based on the predicted value, a leveling index value indicating, in a case in which the application has been constructed on the each of the plurality of execution platforms, at least one of a degree of leveling of a resource usage status on the each of the plurality of execution platforms or a degree of leveling of resource usage statuses among the plurality of the execution platforms; and determining, based on the leveling index value, one of the plurality of execution platforms on which the application is to be constructed from among the plurality of the execution platforms.

### BRIEF DESCRIPTION OF DRAWINGS

FIG. 1 is a diagram for illustrating an example of a communication system in one embodiment of the present invention.

FIG. 2 is a diagram for illustrating an example of the communication system in the one embodiment of the present invention.

FIG. 3 is a diagram for schematically illustrating an example of a network service in the one embodiment of the present invention.

FIG. 4 is a diagram for illustrating an example of links between elements constructed in the communication system in the one embodiment of the present invention.

FIG. 5 is a functional block diagram for illustrating an example of functions implemented by a platform system in the one embodiment of the present invention.

FIG. 6 is a diagram for illustrating an example of data structure of physical inventory data.

FIG. 7 is a diagram for illustrating an example of usage status actual-result-value data.

FIG. 8 is a diagram for illustrating an example of AP resource data.

FIG. 9 is a diagram for illustrating an example of usage status predicted-value data.

FIG. 10 is a flow chart for illustrating an example of a flow of a process performed by the platform system in the one embodiment of the present invention.

### DESCRIPTION OF EMBODIMENTS

One embodiment of the present invention is now described in detail with reference to the drawings.

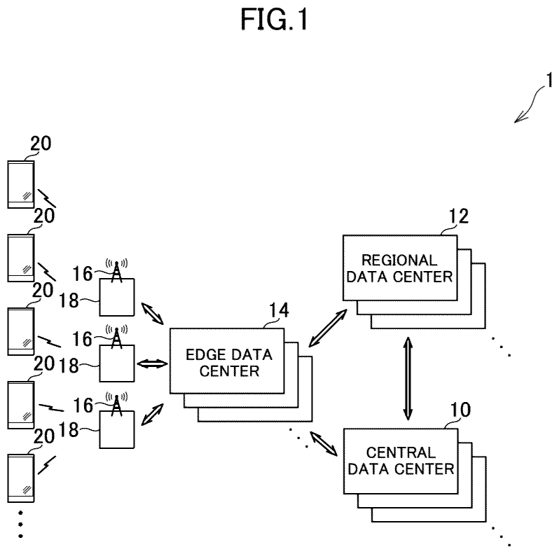

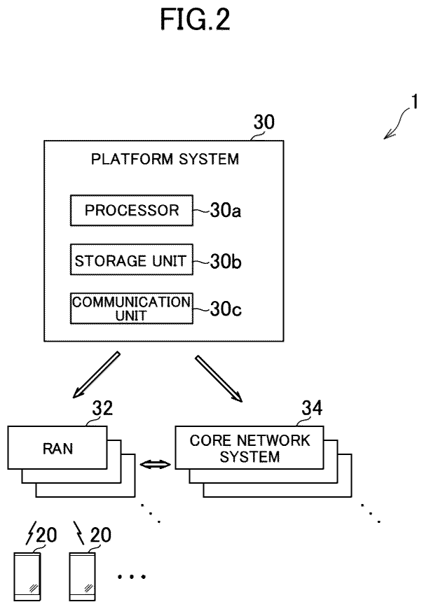

FIG. 1 and FIG. 2 are each a diagram for illustrating an example of a communication system 1 in the one embodiment of the present invention. FIG. 1 is an illustration drawn with attention being given to locations of a data center group included in the communication system 1. FIG. 2 is an illustration drawn with attention being given to various computer systems implemented in the data center group included in the communication system 1.

As illustrated in FIG. 1, the data center group included in the communication system 1 is classified into central data centers 10, regional data centers 12, and edge data centers 14. For example, several central data centers 10 are dispersedly arranged in an area (for example, in Japan) covered by the communication system 1.

For example, tens of regional data centers 12 are dispersedly arranged in the area covered by the communication system 1. For example, when the area covered by the communication system 1 is the entire area of Japan, one or two regional data centers 12 may be arranged in each prefecture.

For example, thousands of edge data centers 14 are dispersedly arranged in the area covered by the communication system 1. In addition, each of the edge data centers 14 can communicate to/from a communication facility 18 provided with an antenna 16. In this case, as illustrated in FIG. 1, one edge data center 14 may be capable of communicating to/from several communication facilities 18. The communication facility 18 may include a computer such as a server computer. The communication facility 18 in this embodiment performs radio communication to/from a user equipment (UE) 20 via the antenna 16. The communication facility 18 provided with the antenna 16 is provided with, for example, a radio unit (RU), which is described later.

A plurality of servers are arranged in each of the central data centers 10, the regional data centers 12, and the edge data centers 14 in this embodiment.

In this embodiment, for example, the central data centers 10, the regional data centers 12, and the edge data centers 14 can communicate to/from one another. Communication can also be performed between the central data centers 10, between the regional data centers 12, and between the edge data centers 14. As illustrated in FIG. 2, the communication system 1 in this embodiment includes a platform system 30, a plurality of radio access networks (RANs) 32, a plurality of core network systems 34, and a plurality of UEs 20. The core network system 34, the RAN 32, and the UE 20 cooperate with each other to implement a mobile communication network.

The RAN 32 is a computer system, which is provided with the antenna 16, and corresponds to an eNodeB (eNB) in a fourth generation mobile communication system (hereinafter referred to as “4G”) and an NR base station (gNB) in a fifth generation mobile communication system (hereinafter referred to as “5G”). The RANs 32 in this embodiment are implemented mainly by server groups arranged in the edge data centers 14 and the communication facilities 18. A part of the RAN 32 (for example, virtual distributed unit (vDU) or virtual central unit (vCU) in 4G or distributed unit (DU) or central unit (CU) in 5G) may be implemented by the central data center 10 or the regional data center 12 instead of the edge data center 14.

The core network system 34 is a system corresponding to an evolved packet core (EPC) in 4G or a 5G core (5GC) in 5G. The core network systems 34 in this embodiment are implemented mainly by server groups arranged in the central data centers 10 or the regional data centers 12.

The platform system 30 in this embodiment is configured, for example, on a cloud platform and includes a processor 30a, a storage unit 30b, and a communication unit 30c, as illustrated in FIG. 2. The processor 30a is a program control device such as a microprocessor which operates in accordance with a program installed in the platform system 30. The storage unit 30b is, for example, a storage element, such as a ROM or RAM, a solid state drive (SSD), a hard disk drive (HDD), or the like. The storage unit 30b stores a program to be executed by the processor 30a, and the like. The communication unit 30c is, for example, a communication interface, such as an NIC or a wireless LAN module. Software-defined networking (SDN) may be implemented in the communication unit 30c. The communication unit 30c exchanges data with the RAN 32 and the core network system 34.

In this embodiment, the platform system 30 is implemented by a server group arranged in the central data center 10. The platform system 30 may be implemented by a server group arranged in the regional data center 12.

In this embodiment, for example, in response to a purchase request for a network service (NS) by a purchaser, the network service for which the purchase request has been made is constructed in the RAN 32 or the core network system 34. Then, the constructed network service is provided to the purchaser.

For example, a network service, such as a voice communication service, a data communication service, or the like, is provided to the purchaser who is a mobile virtual network operator (MVNO). The voice communication service or the data communication service provided in this embodiment is eventually provided to a customer (end user) for the purchaser (MVNO in the above-mentioned example), who uses the UE 20 illustrated in FIG. 1 and FIG. 2. The end user can perform voice communication or data communication to/from other users via the RAN 32 or the core network system 34. The DE 20 of the end user can also access a data network, such as the Internet via the RAN 32 or the core network system 34.

In addition, in this embodiment, an IoT service may be provided to an end user who uses a robot arm, a connected car, or the like. In this case, an end user who uses, for example, a robot arm, a connected car, or the like may be a purchaser of the network service in this embodiment.

In this embodiment, a container-type application execution environment such as Docker is installed in the servers arranged in the central data center 10, the regional data center 12, and the edge data center 14, and containers can be deployed in those servers and operated. In those servers, a cluster (Kubernetes cluster) managed by a container management tool such as Kubernetes may be constructed. Then, a processor on the constructed cluster may execute a container-type application.

The network service provided to the purchaser in this embodiment is formed of one or a plurality of functional units (for example, network function (NF)). In this embodiment, the functional unit is implemented by a containerized network function (CNF) being a container-based functional unit. The functional unit in this embodiment may also correspond to a network node.

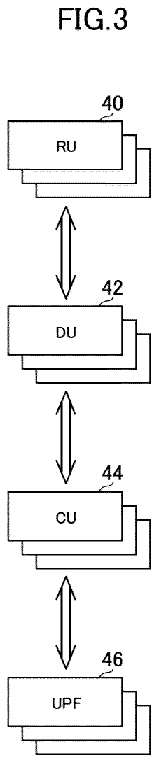

FIG. 3 is a diagram for schematically illustrating an example of an operating network service. The network service illustrated in FIG. 3 includes NEs, such as a plurality of RUs 40, a plurality of DUs 42, a plurality of CUs 44, and a plurality of user plane functions (UPFs) 46, as software elements. The network service also includes other software elements, such as access and mobility management functions (AMFs) and session management functions (SMFs), but description of those elements is omitted. In addition, the network service is implemented on a plurality of servers or other computer resources (hardware elements).

In this embodiment, for example, the network service illustrated in FIG. 3 provides a communication service in a certain area.

In this embodiment, it is also assumed that the plurality of RUs 40, the plurality of DUs 42, the plurality of CUs 44, and the plurality of UPFs 46, which are illustrated in FIG. 3, belong to one end-to-end network slice.

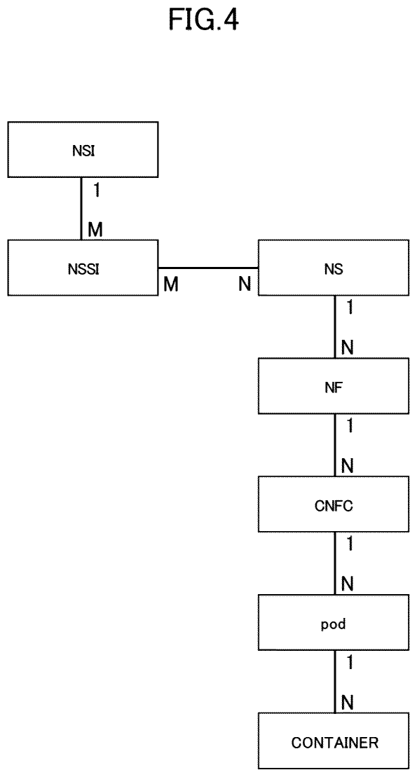

FIG. 4 is a diagram for schematically illustrating an example of links between elements constructed in the communication system 1 in this embodiment.

As illustrated in FIG. 4, a network service (NS), a network function (NF), a containerized network function component (CNFC), a pod, and a container have a hierarchical structure.

The NS corresponds to, for example, a network service formed of a plurality of NEs. In this case, the NS may correspond to an element having a granularity, such as a 5GC, an EPC, a 5G RAN (gNB), or a 4G RAN (eNB).

In 5G, the NF corresponds to an element having a granularity, such as the DU 42, the CU 44, or the UPF 46. The NF also corresponds to an element having a granularity, such as an AMF or an SMF. In 4G, the NF corresponds to an element having a granularity, such as a mobility management entity (MME), a home subscriber server (HSS), a serving gateway (S-GW), a vDU, or a vCU. In this embodiment, for example, one NS includes one or a plurality of NEs. That is, one or a plurality of NFs are under the control of one NS.

The CNFC corresponds to an element having a granularity, such as DU mgmt or DU processing. The CNFC may be a microservice deployed on a server as one or more containers. For example, some CNFCs may be microservices that provide a part of the functions of the DU 42, the CU 44, and the like. Some CNFCs may be microservices that provide a part of the functions of the UPF 46, the AMF, the SMF, and the like. In this embodiment, for example, one NF includes one or a plurality of CNFCs. That is, one or a plurality of CNFCs are under the control of one NF.

The pod refers to, for example, the minimum unit for managing a Docker container by Kubernetes. In this embodiment, for example, one CNFC includes one or a plurality of pods. That is, one or a plurality of pods are under the control of one CNFC.

In this embodiment, for example, one pod includes one or a plurality of containers. That is, one or a plurality of containers are under the control of one pod.

In addition, as illustrated in FIG. 4, a network slice (NSI) and a network slice subnet instance (NSSI) have a hierarchical structure.

The NSIs can be said to be end-to-end virtual circuits that span a plurality of domains (for example, from the RAN 32 to the core network system 34). Each NSI may be a slice for high-speed and high-capacity communication (for example, eMBB), a slice for high-reliability and low-latency communication (for example, URLLC), or a slice for connecting a large quantity of terminals (for example, mMTC). The NSSIs can be said to be single domain virtual circuits dividing an NSI. Each NSSI may be a slice of a RAN domain, a slice of a mobile back haul (MBH) domain, or a slice of a core network domain.

In this embodiment, for example, one NSI includes one or a plurality of NSSIs. That is, one or a plurality of NSSIs are under the control of one NSI. In this embodiment, a plurality of NSIs may share the same NSSI.

In addition, as illustrated in FIG. 4, the NSSI and the NS generally have a many-to-many relationship.

In addition, in this embodiment, for example, one NF can belong to one or a plurality of network slices. Specifically, for example, network slice selection assistance information (NSSAI) including one or a plurality of pieces of sub-network slice selection assist information (S-NSSAI) can be set for one NF. In this case, the S-NSSAI is information associated with the network slice. The NF is not required to belong to the network slice.

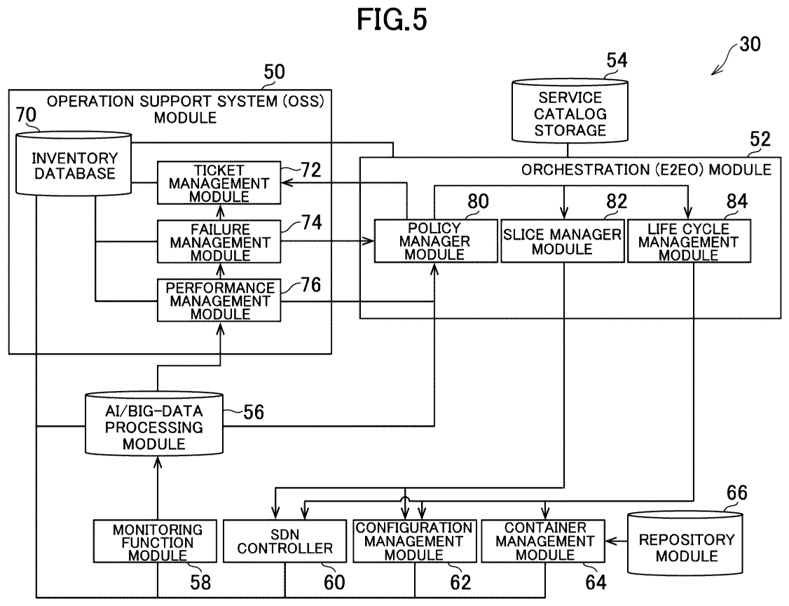

FIG. 5 is a functional block diagram for illustrating an example of functions implemented by the platform system 30 in this embodiment. The platform system 30 in this embodiment is not required to implement all the functions illustrated in FIG. 5, and may implement functions other than those illustrated in FIG. 5.

As illustrated in FIG. 5, the platform system 30 in this embodiment functionally includes, for example, an operation support system (OSS) module 50, an orchestration (end-to-end-orchestration (E2EO)) module 52, a service catalog storage 54, an AI/big-data processing module 56, a monitoring function module 58, an SDN controller 60, a configuration management module 62, a container management module 64, and a repository module 66. The OSS module 50 includes an inventory database 70, a ticket management module 72, a failure management module 74, and a performance management module 76. The E2EO module 52 includes a policy manager module 80, a slice manager module 82, and a life cycle management module 84. Those elements are implemented mainly by the processor 30a, the storage unit 30b and the communication unit 30c.

The above-mentioned functions may be implemented by executing, by the processor 30a, a program that is installed in the platform system 30, which is a computer, and that includes instructions corresponding to the above-mentioned functions. This program may be supplied to the platform system 30 via a computer-readable information storage medium, such as an optical disc, a magnetic disk, a magnetic tape, a magneto-optical disc, a flash memory, or the like, or via the Internet or the like. The above-mentioned functions may also be implemented by a circuit block, a memory, and other LSIs. Further, a person skilled in the art would understand that the above-mentioned functions can be implemented in various forms by only hardware, by only software, or by a combination of hardware and software.

In this embodiment, for example, the container management module 64 executes life cycle management of a container including the construction of the container, such as the deployment and setting of the container.

In this case, the platform system 30 in this embodiment may include a plurality of container management modules 64. In each of the plurality of container management modules 64, a container management tool such as Kubernetes, and a package manager such as Helm may be installed. Each of the plurality of container management modules 64 may execute the construction of a container such as the deployment of the container for a server group (Kubernetes cluster) associated with the container management module 64.

The container management module 64 is not required to be included in the platform system 30. The container management module 64 may be provided in, for example, a server (that is, the RAN 32 or the core network system 34) managed by the container management module 64, or a server that is annexed to the server managed by the container management module 64.

In this embodiment, the repository module 66 stores, for example, a container image of a container included in a functional unit group (for example, NF group) that implements a network service.

In this embodiment, the inventory database 70 is, for example, a database in which inventory information for a plurality of servers managed by the platform system 30 and arranged in the RAN 32 and the core network system 34 is stored.

In this embodiment, for example, the inventory database 70 stores inventory data including physical inventory data and logical inventory data. The inventory data indicates the current statuses of the configuration of an element group included in the communication system 1 and the link between the elements. In addition, the inventory data indicates the status of resources managed by the platform system 30 (for example, resource usage status).

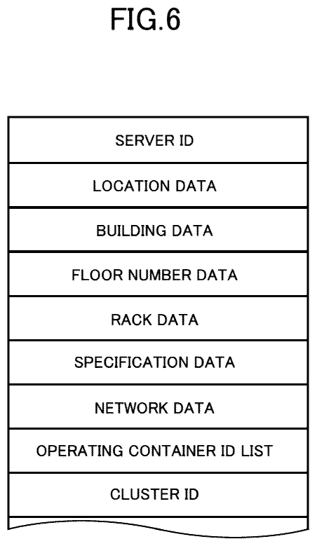

FIG. 6 is a diagram for illustrating an example of data structure of the physical inventory data. The physical inventory data illustrated in FIG. 6 is associated with one server. The physical inventory data illustrated in FIG. 6 includes, for example, a server ID, location data, building data, floor number data, rack data, specification data, network data, an operating container ID list, and a cluster ID.

The server ID included in the physical inventory data is, for example, an identifier of the server associated with the physical inventory data.

The location data included in the physical inventory data is, for example, data indicating the location of the server (for example, the address of the location) associated with the physical inventory data.

The building data included in the physical inventory data is, for example, data indicating a building (for example, a building name) in which the server associated with the physical inventory data is arranged.

The floor number data included in the physical inventory data is, for example, data indicating a floor number at which the server associated with the physical inventory data is arranged.

The rack data included in the physical inventory data is, for example, an identifier of a rack in which the server associated with the physical inventory data is arranged.

The specification data included in the physical inventory data is, for example, data indicating the specifications of the server, such as the number of cores, the memory capacity, and the hard disk capacity, of the server, associated with the physical inventory data.

The network data included in the physical inventory data is, for example, data indicating an NIC included in the server associated with the physical inventory data, the number of ports included in the NIC, and a port ID of each port, and the like.

The operating container ID list included in the physical inventory data is, for example, data indicating a list of identifiers (container IDs) of instances of one or a plurality of containers operating on the server associated with the physical inventory data.

The cluster ID included in the physical inventory data is, for example, an identifier of a cluster (for example, Kubernetes cluster) to which the server associated with the physical inventory data belongs.

In addition, the logical inventory data includes topology data for a plurality of elements included in the communication system 1, which indicates the current status of such link between the elements as illustrated in FIG. 4. For example, the logical inventory data includes topology data including an identifier of a certain NS and an identifier of one or a plurality of NEs under the control of the certain NS. In addition, for example, the logical inventory data includes topology data including an identifier of a certain network slice and an identifier of one or a plurality of NEs belonging to the certain network slice.

The inventory data may also indicate the current status of, for example, a geographical relationship or a topological relationship between the elements included in the communication system 1. The above-mentioned inventory data includes location data indicating locations at which the elements included in the communication system 1 are operating, that is, the current locations of the elements included in the communication system 1. It can be said therefrom that the above-mentioned inventory data indicates current status of the geographical relationship between the elements (for example, geographical closeness between the elements).

In addition, the logical inventory data may include NSI data being data indicating attributes, such as an identifier of an instance of a network slice and the type of the network slice. The logical inventory data may also include NSSI data being data indicating attributes, such as an identifier of an instance of a network slice subnet and the type of the network slice subnet.

In addition, the logical inventory data may include NS data being data indicating attributes, such as an identifier of an instance of an NS and the type of the NS. The logical inventory data may also include NF data indicating attributes, such as an identifier of an instance of an NF and the type of the NF. The logical inventory data may also include CNFC data indicating attributes, such as an identifier of an instance of a CNFC and the type of the CNFC. The logical inventory data may also include pod data indicating attributes, such an identifier of an instance of a pod included in the CNFC and the type of the pod. The logical inventory data may also include container data indicating attributes, such as a container ID of an instance of a container included in the pod and the type of the container.

With the container ID of the container data included in the logical inventory data and the container ID included in the operating container ID list included in the physical inventory data, an instance of the container and the server on which the instance of the container is operating become linked to each other.

Further, data indicating various attributes, such as the host name and the IP address, may be set in the above-mentioned data included in the logical inventory data. For example, the container data may include data indicating the IP address of a container corresponding to the container data. Further, for example, the CNFC data may include data indicating the IP address and the host name of a CNFC indicated by the CNFC data.

The logical inventory data may also include data indicating NSSAI including one or a plurality of pieces of S-NSSAI, which is set for each NF.

Further, the inventory database 70 can appropriately grasp the resource status in cooperation with the container management module 64. Then, the inventory database 70 appropriately updates the inventory data stored in the inventory database 70 based on the latest resource status.

Further, for example, the inventory database 70 updates the inventory data stored in the inventory database 70 in accordance with execution of an action such as construction of a new element included in the communication system 1, a change of a configuration of the elements included in the communication system 1, scaling of the elements included in the communication system 1, or replacement of the elements included in the communication system 1.

In this embodiment, for example, the service catalog storage 54 stores service catalog data.

The service catalog data may include, for example, service template data indicating the logic to be used by the life cycle management module 84 or the like. This service template data includes information required for constructing the network service. Specifically, for example, the service template data includes information defining the NS, the NF, and the CNFC and information indicating an NS-NF-CNFC correspondence relationship. Further, for example, the service template data contains a workflow script for constructing the network service.

An NS descriptor (NSD) is an example of the service template data. The NSD is associated with a network service, and indicates, for example, the types of a plurality of functional units (for example, a plurality of CNFs) included in the network service. The NSD may indicate the number of CNEs or other functional units included in the network service for each type thereof. The NSD may also indicate a file name of a CNED described later, which relates to the CNF included in the network service.

Further, a CNF descriptor (CNFD) is an example of the above-mentioned service template data. The CNFD may indicate computer resources (CPU, memory, hard disk drive, and the like) required by the CNF. For example, the CNFD may also indicate, for each of a plurality of containers included in the CNF, computer resources (CPU, memory, hard disk drive, and the like) required by the container.

The service catalog data may also include information to be used by the policy manager module 80, the information relating to a threshold value (for example, threshold value for abnormality detection) to be compared to the calculated performance index value.

The service catalog data may also include, for example, slice template data indicating the logic to be used by the slice manager module 82. The slice template data includes information required for executing instantiation of the network slice.

The slice template data includes information on a “generic network slice template” defined by the GSM Association (GSMA) (“GSM” is a trademark). Specifically, the slice template data includes network slice template data (NST), network slice subnet template data (NSST), and network service template data. The slice template data also includes information indicating the hierarchical structure of those elements which is illustrated in FIG. 4.

In this embodiment, for example, the life cycle management module 84 constructs a new network service for which a purchase request has been made in response to the purchase request for the NS by the purchaser.

The life cycle management module 84 may execute, for example, the workflow script associated with the network service to be purchased in response to the purchase request. Then, the life cycle management module 84 may execute this workflow script, to thereby instruct the container management module 64 to deploy the container included in the new network service to be purchased. Then, the container management module 64 may acquire the container image of the container from the repository module 66 and deploy a container corresponding to the container image in the server.

In addition, in this embodiment, the life cycle management module 84 executes, for example, scaling or replacement of the element included in the communication system 1. In this case, the life cycle management module 84 may output a container deployment instruction or deletion instruction to the container management module 64. Then, the container management module 64 may execute, for example, a process for deploying a container or a process for deleting a container in accordance with the instruction. In this embodiment, the life cycle management module 84 can execute such scaling and replacement that cannot be handled by Kubernetes of the container management module 64.

The life cycle management module 84 may also output, to the configuration management module 62, a configuration management instruction for a newly constructed element group or an existing element into which a new setting is input. Then, the configuration management module 62 may execute configuration management such as settings in accordance with the configuration management instruction.

The life cycle management module 84 may also output, to the SDN controller 60, an instruction to create a communication route between two IP addresses linked to the two IP addresses.

In this embodiment, the slice manager module 82 executes, for example, instantiation of a network slice. In this embodiment, the slice manager module 82 executes, for example, instantiation of a network slice by executing the logic indicated by the slice template stored in the service catalog storage 54.

The slice manager module 82 includes, for example, a network slice management function (NSMF) and a network slice sub-network management function (NSSMF) described in the 3GPP (trademark) specification “TS28 533.” The NSMF is a function for generating and managing network slices, and provides NSI management. The NSSMF is a function for generating and managing network slice subnets forming a part of a network slice, and provides NSSI management.

The slice manager module 82 may output, to the configuration management module 62, a configuration management instruction related to the instantiation of the network slice. Then, the configuration management module 62 may execute configuration management such as settings in accordance with the configuration management instruction.

The slice manager module 82 may also output, to the SDN controller 60, an instruction to create a communication route between two IP addresses linked to the two IP addresses.

In this embodiment, for example, the configuration management module 62 executes configuration management such as settings of the element group including the NFs in accordance with the configuration management instruction received from the life cycle management module 84 or the slice manager module 82.

In this embodiment, for example, the SDN controller 60 creates the communication route between the two IP addresses linked to the creation instruction in accordance with the instruction to create the communication route, which has been received from the life cycle management module 84 or the slice manager module 82.

In this case, for example, the SDN controller 60 may use segment routing technology (for example, segment routing IPV6 (SRv6)) to construct an NSI and NSSI for the server or an aggregation router present between communication routes. The SDN controller 60 may also generate an NSI and NSSI extending over a plurality of NFs to be set by issuing, to the plurality of NEs to be set, a command to set a common virtual local area network (VLAN) and a command to assign a bandwidth and a priority indicated by the setting information to the VLAN.

The SDN controller 60 may change the upper limit of the bandwidth that can be used for communication between two IP addresses without constructing a network slice.

In this embodiment, the monitoring function module 58 monitors, for example, the element group included in the communication system 1 based on a given management policy. In this case, for example, the monitoring function module 58 may monitor the element group based on a monitoring policy designated by the purchaser when the purchaser purchases the network service.

In this embodiment, the monitoring function module 58 executes monitoring at various levels, such as a slice level, an NS level, an NF level, a CNFC level, and a level of hardware such as the server.

For example, the monitoring function module 58 may set a module for outputting metric data in the hardware such as the server, or a software element included in the communication system 1 so that monitoring can be performed at the various levels described above. In this case, for example, the NE may output the metric data indicating a metric that can be measured (can be identified) by the NF to the monitoring function module 58. Further, the server may output the metric data indicating a metric relating to the hardware that can be measured (can be identified) by the server to the monitoring function module 58.

In addition, for example, the monitoring function module 58 may deploy, in the server, a sidecar container for aggregating the metric data indicating the metrics output from a plurality of containers in units of CNFCs (microservices). This sidecar container may include an agent called “exporter.” The monitoring function module 58 may repeatedly execute a process for acquiring the metric data aggregated in units of microservices from the sidecar container, at predetermined monitoring intervals through use of a mechanism of Prometheus.

The monitoring function module 58 may monitor performance index values regarding performance indices described in, for example, “TS 28.552, Management and orchestration; 5G performance measurements” or “TS 28.554, Management and orchestration; 5G end to end Key Performance Indicators (KPI).” Then, the monitoring function module 58 may acquire metric data indicating the performance index values to be monitored.

Then, for example, when the monitoring function module 58 acquires the above-mentioned metric data, the monitoring function module 58 outputs the metric data to the AI/big data processing module 56.

Further, the elements, such as the network slice, the NS, the NF, the CNFC, that are included in the communication system 1 and the hardware such as the server notify the monitoring function module 58 of various alerts (for example, notify the monitoring function module 58 of an alert with the occurrence of a failure as a trigger).

Then, for example, when the monitoring function module 58 receives the above-mentioned notification of the alert, the monitoring function module 58 outputs the notification to the AI/big-data processing module 56.

In this embodiment, the AI/big-data processing module 56 accumulates, for example, pieces of metric data and notifications of the alerts that have been output from the monitoring function module 58. In addition, in this embodiment, for example, the AI/big-data processing module 56 stores in advance a trained machine learning model.

Then, in this embodiment, for example, the AI/big-data processing module 56 executes, based on the accumulated pieces of metric data and the above-mentioned machine learning model, an estimation process such as a future prediction process for a use status and quality of service of the communication system 1. The AI/big-data processing module 56 may generate estimation result data indicating results of the estimation process.

In this embodiment, for example, the performance management module 76 calculates, based on a plurality of pieces of metric data, a performance index value (for example, KPI) that is based on metrics indicated by those pieces of metric data. The performance management module 76 may calculate a performance index value (for example, performance index value relating to an end-to-end network slice) which is a comprehensive evaluation of a plurality of types of metrics and cannot be calculated from a single piece of metric data. The performance management module 76 may generate comprehensive performance index value data indicating a performance index value being a comprehensive evaluation.

The performance management module 76 may acquire the metric data from the monitoring function module 58 through intermediation of the AI/big-data processing module 56 as illustrated in FIG. 5, or may acquire the metric data directly from the monitoring function module 58. The performance management module 76 may also calculate the performance index value based on the above-mentioned estimation result data.

In this embodiment, the failure management module 74 detects the occurrence of a failure in the communication system 1 based on, for example, at least any one of the above-mentioned metric data, the above-mentioned notification of the alert, the above-mentioned estimation result data, or the above-mentioned comprehensive performance index value data. The failure management module 74 may detect, for example, the occurrence of a failure that cannot be detected from a single piece of metric data or a single notification of the alert, based on a predetermined logic. The failure management module 74 may also generate detection failure data indicating the detected failure.

The failure management module 74 may acquire the metric data and the notification of the alert directly from the monitoring function module 58 or through intermediation of the AI/big-data processing module 56 and the performance management module 76. The failure management module 74 may also acquire the estimation result data directly from the AI/big-data processing module 56 or through intermediation of the performance management module 76.

In this embodiment, the policy manager module 80 executes a predetermined determination process based on, for example, at least any one of the above-mentioned metric data, the above-mentioned notification of the alert, the above-mentioned estimation result data, the above-mentioned comprehensive performance index value data, or the above-mentioned detection failure data.

Then, the policy manager module 80 may execute an action corresponding to a result of the determination process. For example, the policy manager module 80 may output an instruction to construct a network slice to the slice manager module 82. The policy manager module 80 may also output an instruction for scaling or replacement of the elements to the life cycle management module 84 based on the result of the determination process.

In this embodiment, the ticket management module 72 generates, for example, a ticket indicating information to be notified to an administrator of the communication system 1. The ticket management module 72 may generate a ticket indicating details of the detection failure data. The ticket management module 72 may also generate a ticket indicating a value of the performance index value data or the metric data. The ticket management module 72 may also generate a ticket indicating a determination result obtained by the policy manager module 80.

Then, the ticket management module 72 notifies the administrator of the communication system 1 of the generated ticket. The ticket management module 72 may send, for example, an email to which the generated ticket is attached to an email address of the administrator of the communication system 1.

A process relating to addition of each application such as an NF to an execution platform (for example, Kubernetes cluster or server) is further described in the following.

In this embodiment, for example, the monitoring function module 58 monitors a resource usage status on each of a plurality of execution platforms (for example, Kubernetes clusters and servers) included in the communication system 1. Further, in this embodiment, for example, the monitoring function module 58 monitors a resource usage status in each of applications being executed on the execution platforms.

In this case, the resource usage status to be monitored may be at least one of a usage status of a CPU, a usage status of a memory, a usage status of a storage, a usage status of a network, or a usage status of electric power.

Examples of the usage status of the CPU include a CPU usage rate. Examples of the usage status of the memory include a memory usage amount and a memory usage rate. Examples of the usage status of the storage include a storage usage amount and a storage usage rate. Examples of the usage status of the network include a bandwidth usage amount and a bandwidth usage rate. Examples of the usage status of the electric power include a power consumption amount.

Then, the monitoring function module 58 outputs pieces of metric data indicating results of the monitoring to the AI/big-data processing module 56. In this manner, the pieces of metric data are accumulated in the AI/big-data processing module 56.

In this case, it is assumed that, in this embodiment, it has been determined to add an application to the communication system 1. For example, it is assumed that it has been determined to execute a process such as construction of a new NF triggered by the purchase of an NS or scale-out of an NF triggered by an increase in load.

An application determined to be added to the communication system 1, that is, an application to be added to the communication system 1, is hereinafter referred to as “to-be-added application.”

When it has been determined to add the to-be-added application to the communication system 1, the AI/big-data processing module 56 identifies an execution platform on which the to-be-added application is executable from among a plurality of execution platforms included in the communication system 1.

In this case, in this embodiment, for each type of application, a requirement relating to the execution platform on which the application of the type is executable may be determined in advance.

The requirement may be, for example, a requirement relating to hardware (hereinafter referred to as “hardware requirement”). Examples of the hardware requirement may include that single root I/O virtualization (SRIOV) has been implemented, that a graphics processing unit (GPU) has been installed, and that a field-programmable gate array (FPGA) has been installed. Examples of the hardware requirement may also include that the number of mounted GPUs is equal to or larger than a predetermined number, that the size of a mounted memory is equal to or larger than a predetermined size, and that the size of a mounted storage is equal to or larger than a predetermined size.

The requirement may also be, for example, a requirement relating to a location at which the execution platform is arranged.

The above-mentioned requirements may also be described in, for example, the CNED stored in the service catalog storage 54. Then, the AI/big-data processing module 56 may identify the above-mentioned requirement by referring to the CNED stored in the service catalog storage 54.

Then, the AI/big-data processing module 56 may identify the execution platform on which the to-be-added application is executable from among the plurality of execution platforms included in the communication system 1 based on the above-mentioned requirement associated with the type of the to-be-added application. The execution platform identified as the execution platform on which the to-be-added application is executable is hereinafter referred to as “candidate platform.”

Then, the AI/big-data processing module 56 extracts, for example, pieces of metric data indicating the resource usage status in the last period for each of a plurality of candidate platforms. For example, the AI/big-data processing module 56 may extract pieces of metric data indicating the resource usage status collected during the last predetermined length of time (for example, one month).

Then, in this embodiment, for example, the AI/big-data processing module 56 identifies, for each of the plurality of candidate platforms, an actual result value of the resource usage status on the candidate platform. For example, in this embodiment, the AI/big-data processing module 56 identifies, for each of the plurality of candidate platforms, an actual result value of the resource usage status on the candidate platform based on the pieces of metric data extracted for the candidate platform. As described above, the usage status having the actual result value to be identified may be, for example, at least one of the usage status of the CPU, the usage status of the memory, the usage status of the storage, the usage status of the network, or the usage status of the electric power.

In this case, the AI/big-data processing module 56 may extract pieces of metric data indicating the resource usage status for each of the applications being executed on the candidate platform. Then, the AI/big-data processing module 56 may identify a total sum of the actual result values of the resource usage statuses in the respective applications executed on the candidate platform, which are indicated by the extracted pieces of metric data, as the actual result value of the resource usage status on the candidate platform.

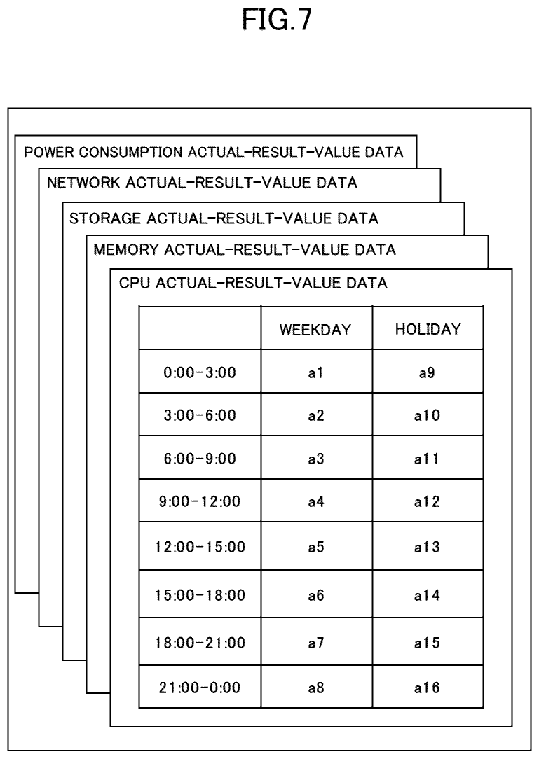

The AI/big-data processing module 56 may also generate, based on the extracted pieces of metric data, usage status actual-result-value data indicating the actual result value of the resource usage status on the candidate platform, which is exemplified in FIG. 7.

The usage status actual-result-value data in this embodiment may include a plurality of separate pieces of actual-result-value data indicating usage statuses of resources of mutually different types. In the example of FIG. 7, the usage status actual-result-value data includes five separate pieces of actual-result-value data (CPU actual-result-value data, memory actual-result-value data, storage actual-result-value data, network actual-result-value data, and power consumption actual-result-value data).

The separate pieces of actual-result-value data may also include a plurality of pieces of period actual-result-value data respectively associated with the period types. In this embodiment, for example, as illustrated in FIG. 7, actual result values of resource usage statuses regarding 16 period types respectively associated with eight time slots of every three hours in terms of a weekday and a holiday are identified. Then, an identified actual result value is set as the value of the piece of period actual-result-value data of the period type associated with the actual result value.

For example, the piece of metric data indicating the usage status of the CPU regarding the time slot of 0:00 to 3:00 on a weekday may be identified from among the pieces of metric data indicating the resource usage status in the last one month. Then, the value of the piece of period actual-result-value data included in the CPU actual-result-value data in association with 0:00 to 3:00 on a weekday may be determined based on the identified piece of metric data. In this case, for example, a representative value al, such as an average value or a maximum value of the CPU usage rate indicated by the identified piece of metric data, may be set as the value of the piece of period actual-result-value data included in the CPU actual-result-value data in association with 0:00 to 3:00 on a weekday.

In the same manner, the values of the other pieces of period actual-result-value data included in the CPU actual-result-value data are also determined, to thereby generate the CPU actual-result-value data illustrated in FIG. 7.

Further, in the same manner, the memory actual-result-value data is generated based on the pieces of metric data indicating the usage status of the memory in the last one month. Further, the storage actual-result-value data is generated based on the pieces of metric data indicating the usage status of the storage in the last one month. Further, the network actual-result-value data is generated based on the pieces of metric data indicating the usage status of the network in the last one month. Further, the power consumption actual-result-value data is generated based on the pieces of metric data indicating the usage status of the electric power in the last one month.

Then, in this embodiment, for example, the AI/big-data processing module 56 identifies, for each of the plurality of candidate platforms, a predicted value of the resource usage status on the execution platform obtained in a case in which the to-be-added application has been constructed on the candidate platform based on the above-mentioned actual result value relating to the candidate platform. The AI/big-data processing module 56 may identify the above-mentioned predicted value for each period type.

In this case, for example, the resource amount required by the to-be-added application may be defined in advance. For example, the resource amount required by the to-be-added application may be described in the above-mentioned CNFD. Further, the AI/big-data processing module 56 may refer to the CNFD stored in the service catalog storage 54 to identify the resource amount required by the to-be-added application.

In this case, for example, the required resource amount may be identified for each of the CPU, the memory, the storage, the network, and the power consumption. The required resource amount may also be identified for each of the above-mentioned plurality of period types.

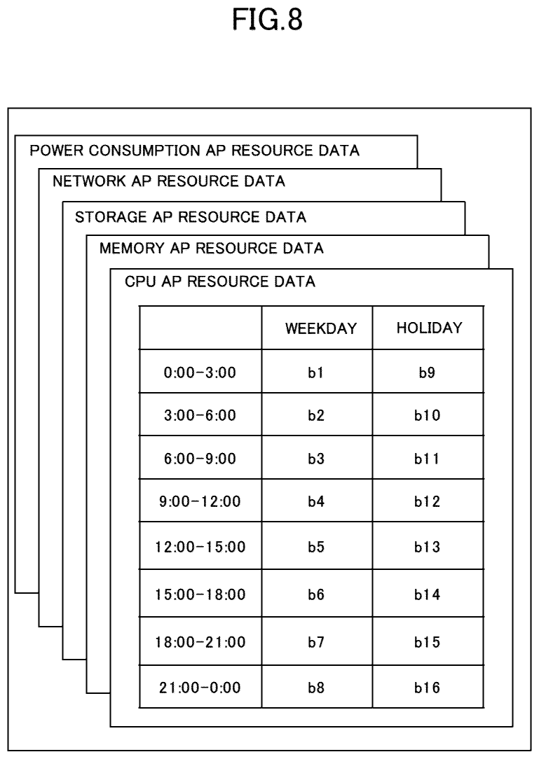

In this case, the AI/big-data processing module 56 may generate AP resource data indicating a resource amount associated with the application, which is exemplified in FIG. 8. The AP resource data may be, for example, data indicating the resource amount required by the to-be-added application.

The AP resource data in this embodiment may include a plurality of separate pieces of AP resource data indicating resource amounts regarding resources of mutually different types. In the example of FIG. 8, the AP resource data includes five separate pieces of AP resource data (CPU AP resource data, memory AP resource data, storage AP resource data, network AP resource data, and power consumption AP resource data).

The separate pieces of AP resource data may also include a plurality of pieces of period AP resource data respectively associated with the period types. In this embodiment, for example, the separate pieces of AP resource data include the pieces of period AP resource data regarding the same 16 period types as those of the pieces of period actual-result-value data included in the usage status actual-result-value data illustrated in FIG. 7.

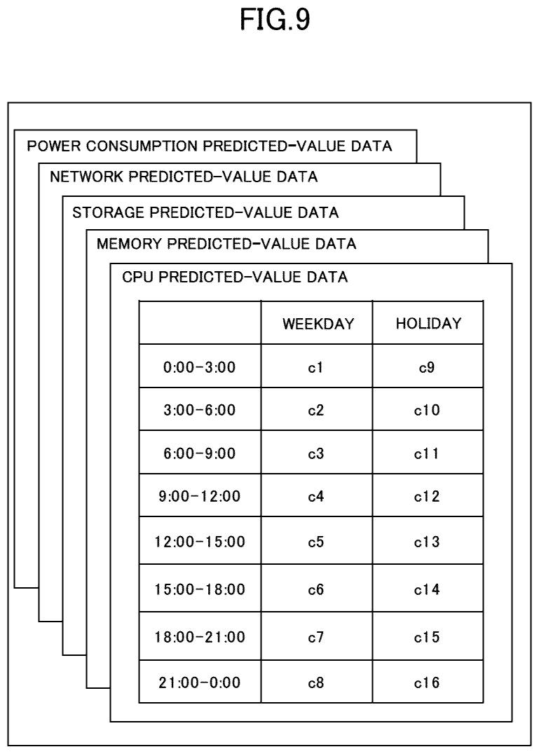

Then, the AI/big-data processing module 56 may identify, for each of the plurality of candidate platforms, the predicted value of the resource usage status on the candidate platform obtained in the case in which the to-be-added application has been constructed on the candidate platform based on the above-mentioned usage status actual-result-value data that are associated with the candidate platform and the above-mentioned AP resource data. The AI/big-data processing module 56 may also generate usage status predicted-value data indicating the predicted value identified in this manner, which is exemplified in FIG. 9.

The usage status predicted-value data in this embodiment may include a plurality of separate pieces of predicted-value data indicating usage statuses of resources of mutually different types. In the example of FIG. 9, the usage status predicted-value data includes five separate pieces of predicted-value data (CPU predicted-value data, memory predicted-value data, storage predicted-value data, network predicted-value data, and power consumption predicted-value data).

In addition, the separate piece of predicted-value data may include a plurality of pieces of period predicted-value data respectively associated with the period types. In this embodiment, for example, as illustrated in FIG. 9, predicted values of resource usage statuses regarding the above-mentioned 16 period types are identified. Then, an identified predicted value is set as the value of the period predicted-value data of the period type associated with the predicted value.

For example, a value cl obtained by adding a value b1 of the CPU AP resource data regarding the time slot of 0:00 to 3:00 on a weekday, which is illustrated in FIG. 8, to the value al, which is illustrated in FIG. 7, may be determined as the value of the period predicted-value data associated with the time slot of 0:00 to 3:00 on a weekday and included in the CPU actual-result-value data. Then, the value cl may be set as the value of the period predicted-value data associated with the time slot of 0:00 to 3:00 on a weekday and included in the CPU predicted-value data.

In the same manner, the values of the other pieces of period predicted-value data included in the CPU predicted-value data are also determined, to thereby generate the CPU predicted-value data, which is illustrated in FIG. 9.

In the same manner as well, the memory predicted-value data is generated based on the memory AP resource data and the memory actual-result-value data. In addition, the storage predicted-value data is generated based on the storage AP resource data and the storage actual-result-value data. Further, the network predicted-value data is generated based on the network AP resource data and the network actual-result-value data. Still further, the power consumption predicted-value data is generated based on the power consumption AP resource data and the power consumption actual-result-value data.

The resource amount required by the to-be-added application may be determined based on the type of the execution platform (for example, scale or specifications of the execution platform). Then, the AP resource data may be generated for each type of the execution platform. Then, the usage status predicted-value data on the candidate platform may be generated based on the usage status actual-result-value data on the candidate platform and the AP resource data generated based on the type of the candidate platform.

A method of generating the usage status predicted-value data is not limited to the above-mentioned method.

For example, the AI/big-data processing module 56 may identify the predicted value of the resource usage status on the candidate platform obtained in the case in which the to-be-added application has been constructed on the candidate platform based on the actual result value of the resource usage status in a running application of the same type as that of the to-be-added application.

For example, the AI/big-data processing module 56 may store a trained machine learning model that has learned a correspondence between the actual result value of the resource usage status before addition of an application of the same type as that of the to-be-added application and the actual result value of the resource usage status after the addition of the application on an execution platform on which the application is operating. For example, this trained machine learning model may output the usage status predicted-value data in response to the input of the usage status actual-result-value data and data indicating the type of the to-be-added application.

Then, the AI/big-data processing module 56 may generate the usage status predicted-value data by inputting the usage status actual-result-value data and the data indicating the type of the to-be-added application to this trained machine learning model.

In this case, the trained machine learning model in this embodiment may be a conservative model that has learned teacher data regarding the execution platform exhibiting a conspicuous difference between the resource usage statuses before and after the addition of the application. For example, for each period type, the execution platform exhibiting the largest difference between the resource usage statuses in the period type between before and after the addition of the application may be identified. Then, the AI/big-data processing module 56 may cause the machine learning model to learn, for each period type, the correspondence between the actual result value of the resource usage status before the addition of the application and the actual result value of the resource usage status after the addition of the application regarding the execution platform identified in this manner. Then, the usage status predicted-value data may be generated through use of the trained machine learning model subjected to the learning for each period type in this manner.

In another case, the usage status predicted-value data may be generated based on a given calculation expression or correspondence rule indicating a relationship between the actual result value and predicted value of the usage status and the usage status actual-result-value data.

In the examples of FIG. 7 to FIG. 9, the number of period types is 16, but the number of period types is not limited to 16. For example, the period types in this embodiment may be a total of 14 period types including two time slots of daytime and nighttime on each day of the week. The number of period types is desired to be suppressed to such a number as to inhibit a calculation amount from becoming excessive.

Further, in this embodiment, for example, for each of the plurality of candidate platforms, the AI/big-data processing module 56 identifies, based on the predicted values identified as described above, the leveling index value indicating, in a case in which the to-be-added application has been constructed on the candidate platform, at least one of a degree of leveling of the resource usage status on the candidate platform or a degree of leveling of the resource usage statuses among the plurality of candidate platforms.

In this case, the AI/big-data processing module 56 may identify the leveling index value based on the above-mentioned predicted value for each period type.

For example, the AI/big-data processing module 56 may identify a leveling index value indicating, in the case in which the to-be-added application has been constructed on the candidate platform, a variation in the predicted values for the respective period types on the candidate platform.

For example, for each of the plurality of candidate platforms, the AI/big-data processing module 56 may identify, for each of the five separate pieces of predicted-value data associated with the candidate platform, a variance in the values of the 16 pieces of period predicted-value data included in the separate pieces of predicted-value data.

Then, the AI/big-data processing module 56 may identify, as the leveling index value associated with the candidate platform, a weighted linear sum of the variances identified for the five separate pieces of predicted-value data provided with a given weight. The leveling index value may be identified based on a standard deviation instead of the variance.

The leveling index value identified in this manner corresponds to an example of the leveling index value indicating, in the case in which the to-be-added application has been constructed on the candidate platform, the degree of leveling of the resource usage status on the candidate platform.

The AI/big-data processing module 56 may also identify, for example, the leveling index value indicating, in the case in which the to-be-added application has been constructed on the candidate platform, a difference between a maximum value and a minimum value of the predicted values for the respective period types on the candidate platform.

For example, for each of the plurality of candidate platforms, the AI/big-data processing module 56 may identify, for each of the five separate pieces of predicted-value data associated with the candidate platform, a difference between a maximum value and a minimum value among the values of the 16 pieces of period predicted-value data included in the separate pieces of predicted-value data.

Then, the AI/big-data processing module 56 may identify, as the leveling index value associated with the candidate platform, a weighted linear sum of the differences identified for the five separate pieces of predicted-value data provided with a given weight.

The leveling index value identified in this manner corresponds to an example of the leveling index value indicating, in the case in which the to-be-added application has been constructed on the candidate platform, the degree of leveling of the resource usage status on the candidate platform.

Further, the AI/big-data processing module 56 may identify the leveling index value indicating, in the case in which the to-be-added application has been arranged on the candidate platform, the variation in the predicted values of the resource usage statuses among the plurality of candidate platforms.

In another case, for each of the plurality of candidate platforms, the AI/big-data processing module 56 may identify the leveling index value indicating, in the case in which the to-be-added application has been arranged on the candidate platform, a total sum of absolute values of differences between the predicted values of the resource usage statuses on the respective plurality of candidate platforms and a predetermined value.

In those cases, in identifying the leveling index value obtained in a case in which the to-be-added application has been arranged on a certain candidate platform, the value of the usage status predicted-value data corresponds to the predicted value of the resource usage status for the certain candidate platform, and for other candidate platforms, the values of the usage status actual-result-value data correspond to the predicted values of the resource usage statuses.

For example, it is assumed that the number of candidate platforms is “n”. In this case, for example, for each of the “n” candidate platforms, the AI/big-data processing module 56 may calculate, based on the usage status actual-result-value data associated with the candidate platform, an actual-result resource usage rate associated with the candidate platform. For example, a representative value of the actual result value of the CPU usage rate, a representative value of the actual result value of the memory usage rate, a representative value of the actual result value of the storage usage rate, and representative value of the actual result value of the bandwidth usage rate may be calculated for each of a plurality of period types. Then, a representative value regarding those four representative values may be calculated as the actual-result resource usage rate associated with the candidate platform.

Further, for example, for each of the “n” candidate platforms, the AI/big-data processing module 56 may calculate, based on the usage status predicted-value data associated with the candidate platform, a predicted resource usage rate associated with the candidate platform. For example, a representative value of the predicted value of the CPU usage rate, a representative value of the predicted value of the memory usage rate, a representative value of the predicted value of the storage usage rate, and a representative value of the predicted value of the bandwidth usage rate may be calculated for each of a plurality of period types. Then, a representative value regarding those four representative values may be calculated as the predicted resource usage rate associated with the candidate platform.

Examples of the above-mentioned representative values include an average value and a maximum value. In addition, examples of the above-mentioned “representative value regarding four representative values” include an average value of the above-mentioned four average values, a maximum value of the above-mentioned four average values, an average value of the above-mentioned four maximum values, and a maximum value of the above-mentioned four maximum values.

Then, the AI/big-data processing module 56 may calculate the leveling index value associated with the candidate platform for each of the “n” candidate platforms based on the above-mentioned actual-value resource usage rate and the above-mentioned predicted resource usage rate.

For example, the value of the predicted resource usage rate of a focused platform being a certain candidate platform and the values of the actual-value resource usage rates of the other (n−1) candidate platforms may be identified. Then, the variance or standard deviation of the identified “n” values may be calculated as the leveling index value associated with the focused platform.

In another case, a difference between the value of the predicted resource usage rate regarding the focused platform and a predetermined value (for example, 70%) and a difference between the value of the actual-value resource usage rates regarding the other (n−1) candidate platforms and the predetermined value (for example, 70%) may be identified. Then, a total sum of absolute values of the identified “n” differences may be calculated as the leveling index value associated with the focused platform.

The leveling index value identified in this manner corresponds to an example of the leveling index value indicating the degree of leveling of the resource usage statuses among the plurality of candidate platforms.

Further, in this embodiment, the leveling index value associated with the candidate platform may be identified based on, in the case in which the to-be-added application has been constructed on the candidate platform, a first leveling index value indicating the degree of leveling of the resource usage status on the candidate platform and a second leveling index value indicating the degree of leveling of the resource usage statuses among the plurality of candidate platforms.

For example, an average value of the first leveling index value and the second leveling index value may be identified as the leveling index value associated with the candidate platform. In another case, for example, a weighted average value of the first leveling index value and the second leveling index value based on a given weight may be identified as the leveling index value associated with the candidate platform.

Then, the policy manager module 80 determines the execution platform on which the to-be-added application is to be constructed from among the plurality of candidate platforms based on the leveling index value identified as described above.

For example, when the leveling index value indicating, in the case in which the to-be-added application has been constructed on the candidate platform, the variation in the predicted values for the respective period types on the candidate platform is identified, the execution platform on which the to-be-added application is to be constructed may be determined based on smallness of the variation indicated by the leveling index value.

Further, for example, when the leveling index value indicating, in the case in which the to-be-added application has been arranged on the candidate platform, the variation in the predicted values of the resource usage statuses among the plurality of candidate platforms is identified, the candidate platform on which the to-be-added application is to be constructed may be determined based on the smallness of the variation indicated by the leveling index value.

For example, the candidate platform associated with the smallest value among the leveling index values indicating the variations respectively associated with the plurality of candidate platforms may be determined as the execution platform on which the to-be-added application is to be constructed.

Further, for example, when the leveling index value indicating, in the case in which the to-be-added application has been constructed on the candidate platform, the difference between the maximum value and the minimum value of the predicted values for the respective period types on the candidate platform is identified, the execution platform on which the to-be-added application is to be constructed may be determined based on smallness of the difference indicated by the leveling index value. For example, the candidate platform associated with the smallest value among the leveling index values indicating the differences respectively associated with the plurality of candidate platforms may be determined as the execution platform on which the to-be-added application is to be constructed.

Further, for example, when the leveling index value indicating, in the case in which the to-be-added application has been arranged on the candidate platform, the total sum of the absolute values of the differences between the predicted values of the resource usage statuses on the respective plurality of candidate platforms and the predetermined value is identified, the execution platform on which the to-be-added application is to be constructed may be determined based on smallness of the total sum of the absolute values of the differences indicated by the leveling index values. For example, the candidate platform associated with the smallest value among the leveling index values indicating the total sum of the absolute values of the differences respectively associated with the plurality of candidate platforms may be determined as the execution platform on which the to-be-added application is to be constructed.

Then, the life cycle management module 84, the container management module 64, and the configuration management module 62 construct the to-be-added application on the execution platform determined as the execution platform on which the to-be-added application is to be constructed as described above.

The leveling index value described above becomes smaller as the degree of leveling becomes higher. Such a leveling index value as to become larger as the degree of leveling becomes higher may be used instead. In this case, the candidate platform associated with the largest value among the leveling index values associated with the plurality of candidate respectively platforms is determined as the execution platform on which the to-be-added application is to be constructed.

For example, when each application is constructed on the execution platform in a round robin, there are some cases in which the resources of the execution platforms cannot be utilized effectively. When, for example, the population of an area covered by each application executed on an execution platform is diverse, the resource usage status may vary depending on the execution platform.

In this embodiment, the execution platform on which the to-be-added application is to be constructed is determined based on the above-mentioned leveling index value, thereby enabling the resources of the execution platforms to be utilized effectively.

The leveling index value in this embodiment may indicate a degree of improvement in the leveling of the resource usage statuses before and after the addition of the to-be-added application.

Further, the candidate platform associated with the predicted resource usage rate exceeding a predetermined threshold value may be excluded from the execution platforms on which the to-be-added application is to be constructed. That is, the execution platform on which the to-be-added application is to be constructed may be determined from among the candidate platforms associated with the predicted resource usage rate that does not exceed the predetermined threshold.

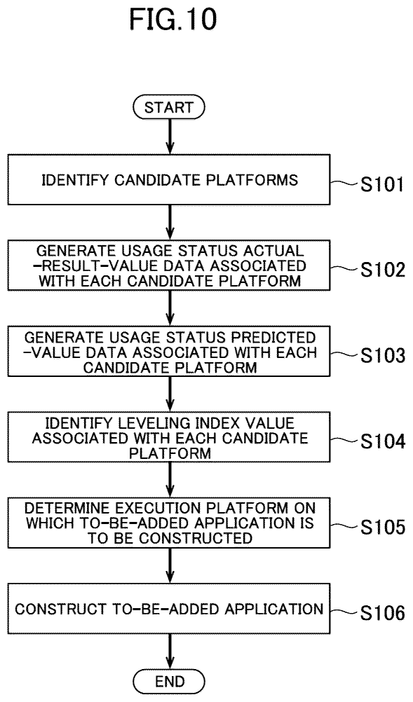

Now, an example of a flow of a process performed by the platform system 30 in this embodiment with the determination to add the application to the communication system 1 as a trigger is described with reference to a flow chart exemplified in FIG. 10. In this process example as well, the application determined to be added is referred to as “to-be-added application.”

First, the AI/big-data processing module 56 identifies a plurality of candidate platforms from among a plurality of execution platforms (for example, Kubernetes clusters) included in the communication system 1 (Step S101).

Then, the AI/big-data processing module 56 generates, for each of the plurality of candidate platforms, the usage status actual-result-value data associated with the candidate platform (Step S102).

Then, the AI/big-data processing module 56 generates, for each of the plurality of candidate platforms, the usage status predicted-value data associated with the candidate platform (Step S103).

Then, the AI/big-data processing module 56 identifies, for each of the plurality of candidate platforms, the leveling index value associated with the candidate platform (Step S104). As described above, in the process step of Step S104, for each of the plurality of candidate platforms, the leveling index value associated with the candidate platform may be identified based on the usage status predicted-value data associated with the candidate platform. In another case, for each of the plurality of candidate platforms, the leveling index value associated with the candidate platform may be identified based on the usage status predicted-value data associated with the candidate platform and the usage status actual-result-value data associated with the other candidate platforms.

Then, the policy manager module 80 determines the execution platform on which the to-be-added application is to be constructed from among the plurality of candidate platforms identified in the process step of Step S101 based on the leveling index value identified for each of the plurality of candidate platforms in the process step of Step S104 (Step S105).

Then, the life cycle management module 84, the container management module 64, and the configuration management module 62 construct the to-be-added application on the execution platform determined in the process step of Step S105 (Step S106), and the process illustrated in this process example is ended.

It should be noted that the present invention is not limited to the above-mentioned embodiment.

For example, the execution platform in this embodiment may be a Kubernetes cluster. The execution platform in this embodiment may also be a server.

Further, the to-be-added application in this embodiment may be a network function included in the communication system 1 or an application other than the network function, such as an application for big data analysis or an AI.

Further, the leveling index value is described above as being calculated based on all of the usage status of the CPU, the usage status of the memory, the usage status of the storage, the usage status of the network, and the usage status of the electric power, but the leveling index value may be calculated based on some of those statuses. For example, the leveling index value may be calculated based on any one of the usage status of the CPU, the usage status of the memory, the usage status of the storage, the usage status of the network, or the usage status of the electric power.

Further, the functional unit in this embodiment is not limited to those illustrated in FIG. 3. For example, the functional unit in this embodiment may be an access and mobility management function (AMF), a session management function (SMF), or another network node.

Further, the functional unit in this embodiment is not required to be an NF in 5G. For example, the functional unit in this embodiment may be an eNodeB, a vDU, a vCU, a packet data network gateway (P-GW), a serving gateway (S-GW), a mobility management entity (MME), a home subscriber server (HSS), or another network node in 4G.

Further, the functional unit in this embodiment is not required to be a CNF, and may be a virtualized network function (VNF), which is a virtual-machine-based (VM-based) functional unit using a hypervisor-type or host-type virtualization technology. Further, the functional unit in this embodiment is not required to be implemented by software, and may be implemented by hardware, for example, by an electronic circuit. Further, the functional unit in this embodiment may be implemented by a combination of an electronic circuit and software.

1. An execution platform determination system, comprising:
at least one processor; and
at least one memory device storing instruction which, when executed by the at least one processor, cause the at least one processor to perform operations comprising:
identifying, for each of a plurality of execution platforms on which an application to be added is executable, an actual result value of a resource usage status on the each of the plurality of execution platforms;
identifying, for each of the plurality of execution platforms, a predicted value of the resource usage status on the each of the plurality of execution platforms obtained in a case in which the application has been constructed on the each of the plurality of execution platforms based on the actual result value relating to the each of the plurality of execution platforms;
identifying, for each of the plurality of execution platforms, based on the predicted value, a leveling index value indicating, in a case in which the application has been constructed on the each of the plurality of execution platforms, at least one of a degree of leveling of a resource usage status on the each of the plurality of execution platforms or a degree of leveling of resource usage statuses among the plurality of the execution platforms; and
determining, based on the leveling index value, one of the plurality of execution platforms on which the application is to be constructed from among the plurality of the execution platforms.

2. The execution platform determination system according to claim 1, wherein identifying the actual result value comprises identifying a total sum of actual result values of resource usage statuses in respective applications executed on the each of the plurality of execution platforms as the actual result value of the resource usage status on the each of the plurality of execution platforms.

3. The execution platform determination system according to claim 1, wherein identifying the predicted value comprises identifying the predicted value based on the actual result value of the resource usage status in a running application of the same type as the type of the application to be added.

4. The execution platform determination system according to claim 1,
wherein identifying the predicted value comprises identifying predicted values for respective period types, and
wherein identifying the leveling index value comprises identifying the leveling index value based on the predicted values for the respective period types.

5. The execution platform determination system according to claim 4,
wherein identifying the leveling index value comprises identify the leveling index value indicating, in the case in which the application has been constructed on the each of the plurality of execution platforms, a variation in the predicted values for the respective period types on the each of the plurality of execution platforms, and
wherein determining comprises determining, based on smallness of the variation indicated by the leveling index value, the one of the plurality of execution platforms on which the application is to be constructed.

6. The execution platform determination system according to claim 4,
wherein identifying the leveling index value comprises identifying the leveling index value indicating, in the case in which the application has been constructed on the each of the plurality of execution platforms, a difference between a maximum value and a minimum value of the predicted values for the respective period types on the each of the plurality of execution platforms, and
wherein determining comprises determining, based on smallness of the difference indicated by the leveling index value, the one of the plurality of execution platforms on which the application is to be constructed.

7. The execution platform determination system according to claim 1,
wherein identify the leveling index value comprises identifying, for each of the plurality of the execution platforms, the leveling index value indicating, in a case in which the application has been arranged on the each of the plurality of the execution platforms, a variation in the predicted values of the resource usage statuses among the plurality of the execution platforms, and
wherein determining comprises determining, based on smallness of the variation indicated by the leveling index value, the one of the plurality of execution platforms on which the application is to be constructed.

8. The execution platform determination system according to claim 1,
wherein identifying the leveling index value comprises identify, for each of the plurality of execution platforms, the leveling index value indicating, in a case in which the application has been arranged on the each of the plurality of the execution platforms, a total sum of absolute values of differences between the predicted values of the resource usage statuses on the respective plurality of execution platforms and a predetermined value, and
wherein determining comprises determining, based on smallness of the total sum of the absolute values of the differences indicated by the leveling index value, the one of the plurality of execution platforms on which the application is to be constructed.

9. The execution platform determination system according to claim 1, the operations further comprise constructing the application on the determined one of the plurality of execution platforms.

10. The execution platform determination system according to claim 1, wherein the execution platform is a Kubernetes cluster.

11. The execution platform determination system according to claim 1, wherein the application is an application included in a communication system.

12. The execution platform determination system according to claim 11, wherein the application is a network function.

13. The execution platform determination system according to claim 1, wherein the resource usage status is at least one of a usage status of a CPU, a usage status of a memory, a usage status of a storage, a usage status of a network, or a usage status of electric power.

14. An execution platform determination method, comprising:
identifying, for each of a plurality of execution platforms on which an application to be added is executable, an actual result value of a resource usage status on the each of the plurality of execution platforms;
identifying, for each of the plurality of execution platforms, a predicted value of the resource usage status on the each of the plurality of execution platforms obtained in a case in which the application has been constructed on the each of the plurality of execution platforms based on the actual result value relating to the each of the plurality of execution platforms;
identifying, for each of the plurality of execution platforms, based on the predicted value, a leveling index value indicating, in a case in which the application has been constructed on the each of the plurality of execution platforms, at least one of a degree of leveling of a resource usage status on the each of the plurality of execution platforms or a degree of leveling of resource usage statuses among the plurality of the execution platforms; and
determining, based on the leveling index value, one of the plurality of execution platforms on which the application is to be constructed from among the plurality of the execution platforms.
